(19) United States
(12) Patent Application Publication
(10) Pub. No.: US 2012/0120175 A1
(43) Pub. Date: May 17, 2012

(54) ELECTRONIC STAMPER

(75) Inventors: Philip G. Wessells, Mill Valley, CA (US); Michael E. Woods, San Rafael, CA (US)

(73) Assignee: Grifiti LLC, Jackson, WY (US)

(21) Appl. No.: 12/946,346

(22) Filed: Nov. 15, 2010

(51) Int. Cl. B41J 3/36

(52) U.S. Cl. 347/109

(57) ABSTRACT

A versatile and convenient electronic stamper that overcomes limitations of conventional systems including greater robustness in message transfer as well as disproportionate costs. A print solution includes a hand-held housing defining a print area aperture; and a printhead array including a plurality of rows and a plurality of columns of print elements, the printhead sized to substantially cover the print area aperture and configured to apply a print element to any part of the print area aperture without relative motion between the print head and the print area aperture.

### BACKGROUND OF THE INVENTION

The present invention generally relates to office “stamper” replacement, and more particularly to electronic indicia application systems and methods for replacing stamper products.

As used herein, “stamper” refers to the ubiquitous “stamp” type product used in businesses and homes all over the world. This class of product includes rubber stamps, business stamps, ink stamps, “print” kits, and the like, whether they are self-inking or use an inking stamp pad or replaceable cartridge. For mechanical stampers, there are products that are single function (i.e., they apply a single “message” to a receiving article when “stamped” and there are products that are multifunction and may be configured to apply a message selected from a set of messages.

These products and methods are ubiquitous because of their simplicity, effectiveness, and cost. There are well-known drawbacks to these systems including uniform and consistent application of ink to the stamp, adaptation of message to varying conditions, and management of stamp proliferation.

Solutions to these drawbacks have included electric/electronic stamper products. These products typically are variations on the theme of a portable, handheld, light-weight printer. There is some type of mechanical or electromechanical element that applies the desired message by successively applying message elements while the entire message is printed.

Conventional solutions include moving a printhead with actuator within a printer housing over a print area (either single pass or multiple pass) or manually moving a “fixed” printhead by “waving” an entire printer device (i.e., both housing and printhead) across the print area. The movements may include all types of relative motion—including single pass, multipass, rotation, pivot, arcuate, and complex combinations of these.

FIG. 1 is a conventional print solution 100 including a single-pass moving printhead 105 printing to a print area 110. FIG. 2 is a conventional print solution 200 including a multi-pass moving printhead 205 printing to print area 110 shown in FIG. 1. FIG. 3 is a conventional print solution 300 including movement of a housing of a printer 305, the housing including a fixed printhead 310 printing to print area 110. In solution 100 and solution 200, the printer housing defines a print area aperture, which in an electronic stamper type product, the print area aperture equals the total print area. In some printers, the medium to be printed (e.g., the sheet of paper) advances through the aperture with the printhead making a single pass or multipass for each incremental advance. In solution 300, one of the advantages is that the print area is not constrained by the size of the printer housing.

While these products begin to address some of the drawbacks of existing stamper products and methods, they introduce new concerns and disadvantages. The electromechanical stamper of the prior art often requires that the receiving surface be firmer and flatter than is often required of the more traditional pure mechanical stamp product. But more importantly, the electromechanical products require that the stamper be placed and maintained in location during the duration of the printing process and any motion before completion risks misalignment of the message elements which can distort the ultimate message to be applied. These solutions are generally slow and require significant power which adds costs for batteries and/or recharging systems. Further, these solutions start to become expensive and disproportionately so in comparison to simple hand-held single-message rubber stamp.

What is needed is a versatile and convenient electronic stamper that overcomes limitations of conventional systems including greater robustness in message transfer as well as disproportionate costs.

### BRIEF SUMMARY OF THE INVENTION

Disclosed is a versatile and convenient electronic stamper that overcomes limitations of conventional systems including greater robustness in message transfer as well as disproportionate costs. A print solution includes a hand-held housing defining a print area aperture; and a printhead array including a plurality of rows and a plurality of columns of print elements, the printhead sized to substantially cover the print area aperture and configured to apply a print element to any part of the print area aperture without relative motion between the print head and the print area aperture.

A print method, the method including; a) placing a hand-held printer housing over a print area; and b) transferring an image to the print area from the hand-held printer without relative motion between any element of the hand-held printer and the print area.

In these embodiments, the printhead covers the entire printable print area (which may be a print area aperture to a larger medium). There are multiple print elements (nozzles, heating elements, cartridges, and the like as virtually any print technology may be adapted as described herein) spread out appropriately over the printhead to define the desired coverage and resolution of the transferred image. Individual elements are trigged based upon desired indicia to be transferred. There are no moving parts for the image transfer system—the housing, print area and print head remain relatively fixed. Less power is required to activate the particular print elements and there is no movement of a printhead, particularly “high speed” movement to improve its function as a stamper embodiment. The slower the conventional print solution moves the printhead, the longer a user is required to maintain the stamper location fixed. Movement before completion risks distortion and the longer it takes, the more a user is dissatisfied with the “stamping” function.

Other benefits and features will be apparent upon a review of the figures and specification.

### BRIEF DESCRIPTION OF THE DRAWINGS

FIG. 1 is a conventional print solution including a single-pass moving printhead printing to a print area;

FIG. 2 is a conventional print solution including a multi-pass moving printhead printing to the print area shown in FIG. 1;

FIG. 3 is a conventional print solution including movement of a housing of a printer, the housing including a fixed printhead printing to the print area 110 shown in FIG. 1;

FIG. 4 is a print solution embodiment of the present invention including a fixed printhead printing to a print area without relative motion between the printhead and the print area;

FIG. 5 is a detailed representation of an embodiment of a printhead shown in FIG. 4;

FIG. 6 is a representative view of a stamper system embodiment including the present invention; and

FIG. 7 is a representative view of an alternative stamper system embodiment including the present invention.

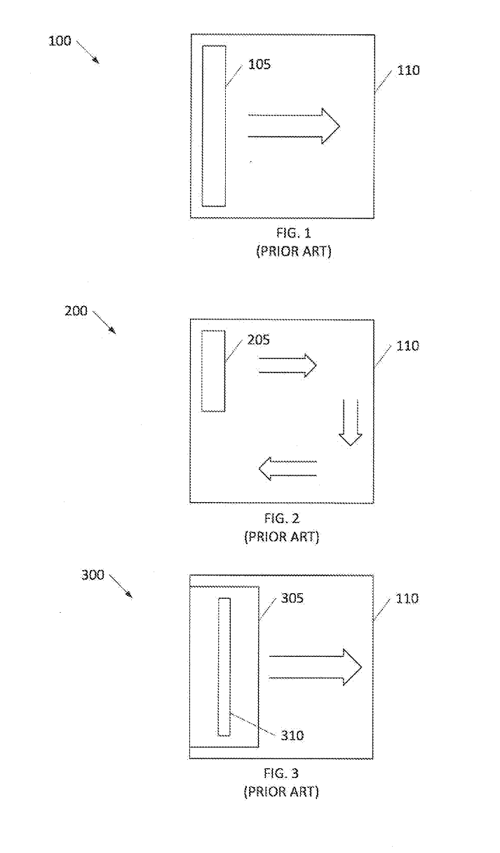

### DETAILED DESCRIPTION OF THE INVENTION

Embodiments of the present invention provide apparatus and method for a versatile and convenient electronic stamper that overcomes limitations of conventional systems including greater robustness in message transfer as well as disproportionate costs. The following description is presented to enable one of ordinary skill in the art to make and use the invention and is provided in the context of a patent application and its requirements.

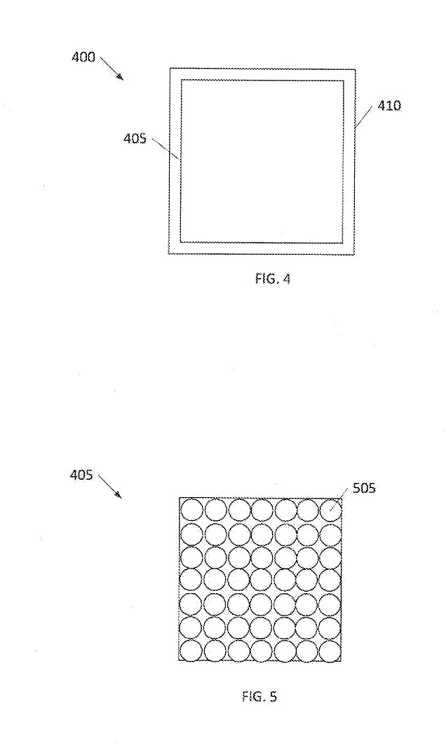

FIG. 4 is a print solution embodiment 400 of the present invention including a fixed printhead 405 printing to a print area 410 without relative motion between printhead 405 and print area 410. FIG. 5 is a detailed representation of an embodiment of printhead 405 shown in FIG. 4. Printhead 405 includes an array (shown as a regular matrix of M×N print elements 505). In a preferred embodiment, print elements 505 are inkjets, though other implementations may use a different imaging technology. In the preferred embodiments, the desired technologies provide for an image transfer system using few, if any, relatively moving components. A fixed printhead having print elements that directly transfer image elements is preferred, like the inkjet technology. As noted herein, there are thermal systems that transfer “ink” of some type or another to a medium in response to selective activation of print elements of the fixed printhead. The technologies may include, in addition to those expressly described herein, dye sublimation, dye thermal transfer, wax melt, gel transfer, and the like. The systems described herein have usefulness in the electronic “stamper” field even when employing monochromatic imaging elements. Manual stamps often employ just a single color: typically black or red. While useful in this context, the print elements of the preferred embodiments will include multicolor, so the print elements shown herein may, in fact, include two or more sub-pixel elements (not explicitly shown) making up any particular picture element.

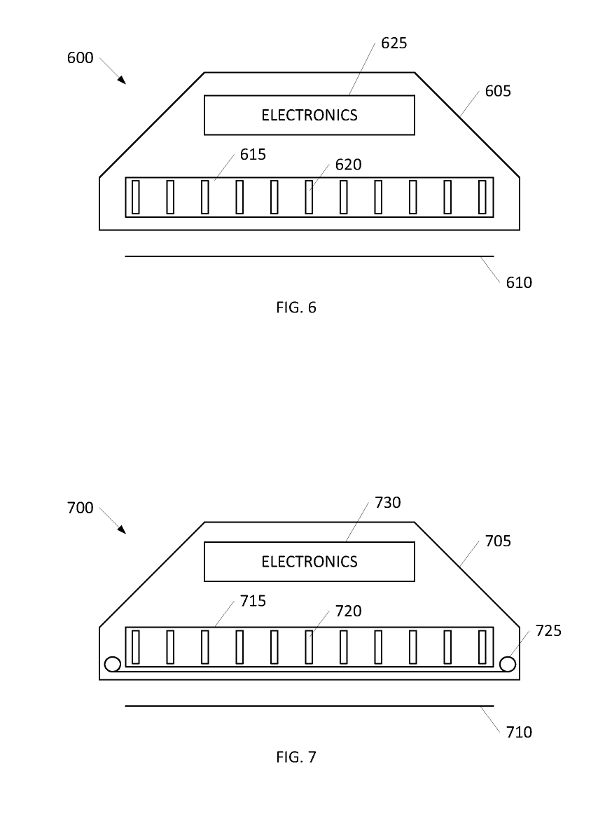

FIG. 6 is a representative view of an embodiment for a stamper system 600 including the present invention. System 600 includes a hand-held housing 605 (sized for single-handed grip and use) overlying a print area 610. Housing 605 includes a printhead 615 supporting an array of print elements 620 (e.g., inkjets and the like) that transfer image elements to any location of print area 610 without any relative movement between housing 605, print area 610, and print head 615. System 600 also includes an electronics subsystem 625 including a processing unit, memory, and an energy storage system for controlling the print elements in response to a user-triggered signal from an interface (not shown). The interface permits selection of particular images and other operational and monitoring features, as implemented. Some embodiments may include a communication mode for sending or receiving data (e.g., images, controls, processor executable instructions, and the like) for storage in the memory. The communication mode may be wired or wireless.

FIG. 7 is a representative view of an alternative embodiment for a stamper system 700 including the present invention. System 700 includes a hand-held housing 705 (sized for single-handed grip and use) overlying a print area 710. Housing 705 includes a printhead 715 supporting an array of print elements 720 (e.g., resistors, heating elements, and the like) that transfer image elements to any location of print area 720 by use of a thermal ribbon 725 without any relative movement between housing 705, print area 710, and print head 715. System 700 also includes an electronics subsystem 730 including a processing unit, memory, and an energy storage system for controlling the print elements in response to a user-triggered signal from an interface (not shown). The interface permits selection of particular images and other operational and monitoring features, as implemented. Some embodiments may include a communication mode for sending or receiving data (e.g., images, controls, processor executable instructions, and the like) for storage in the memory. The communication mode may be wired or wireless.

In these embodiments, the printhead covers the entire printable print area (which may be a print area aperture to a larger medium). There are multiple print elements (nozzles, heating elements, cartridges, and the like as virtually any print technology may be adapted as described herein) spread out appropriately over the printhead to define the desired coverage and resolution of the transferred image. Individual elements are trigged based upon desired indicia to be transferred. There are no moving parts for the image transfer system—the housing, print area and print head remain relatively fixed. Less power is required to activate the particular print elements and there is no movement of a printhead, particularly “high speed” movement to improve its function as a stamper embodiment. The slower the conventional print solution moves the printhead, the longer a user is required to maintain the stamper location fixed. Movement before completion risks distortion and the longer it takes, the more a user is dissatisfied with the “stamping” function. It should be noted that hand-held electronic devices are generally more robust with longer times between failure the fewer the number of moving parts that are associated with the product. Embodiments of the present invention desirably have very few moving parts, zero moving parts with respect to the image transfer system itself.

Density of print elements determines highest resolution which offers an option of activating fewer elements to lower resolution. It is the case that for a stamper implementation, super-fine resolution is not required. Part of the advantage of these embodiments is the use of repurposed technology to decrease resolution (as opposed to increases in resolution for newer printing technologies). By adapting existing and new technologies to be coarser resolution, it is possible to achieve great results at lower costs. There is often more margin, making manufacturing and use simpler and more efficient (and less costly), by decreasing resolution and speed.

The preceding describes a preferred electronic stamper that features and arrangements addressing limitations in conventional stampers, mechanical and electronic. Manufacturers, based upon their individual decision-making, will offer different sizes and resolutions of these systems, with differing imaging systems, and including a feature set that will likely vary from the feature set described herein, to meet the needs of its customers and clients, all these variations are included within the scope of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A print solution, comprising:
a hand-held housing defining a print area aperture; and
a printhead array including a plurality of rows and a plurality of columns of print elements, said printhead sized to substantially cover said print area aperture and configured to apply a print element to any part of said print area aperture without relative motion between said print head and said print area aperture.

2. The printhead array of claim 1 wherein said print elements include inkjet nozzles.

3. The printhead array of claim 1 wherein said print elements include thermal transfer elements.

4. A print method, the method comprising the steps of:
a) placing a hand-held printer housing over a print area; and
b) transferring an image to said print area from said hand-held printer without relative motion between any element of said hand-held printer and said print area.

5. The print method of claim 4 wherein said print elements include inkjet nozzles.

6. The print method of claim 4 wherein said print elements include thermal transfer elements.
